(19) United States
(12) Patent Application Publication
(10) Pub. No.: US 2026/0126988 A1
(43) Pub. Date: May 7, 2026

(54) SYSTEMS AND METHODS FOR IMPROVING THE EFFECTIVENESS OF CODE REVIEWS

(71) Applicant: JPMORGAN CHASE BANK, N.A., New York, NY (US)

(72) Inventors: Gerald RADACK, Havertown, PA (US); Ravi KURUGANTHY, Frisco, TX (US); Venkata Mohit TAMANAMPUDI, New Castle, DE (US)

(21) Appl. No.: 19/176,806

(22) Filed: Apr. 11, 2025

Related U.S. Application Data
(60) Provisional application No. 63/715,236, filed on Nov. 1, 2024.

(51) Int. Cl. G06F 8/71; G06F 21/53

(52) U.S. Cl. CPC G06F 8/71; G06F 21/53

(57) ABSTRACT

Systems and methods for improving the effectiveness of code reviews are disclosed. A method may include: receiving, from a reviewer computer program for a reviewer, a request for code to review; retrieving the code from a code repository; identifying instances of harmless error code, wherein the instances of harmless error code does not impact execution of the code when embedded in the code; embedding the instances of harmless error code in the code; providing the code to the reviewer computer program; receiving a review of the code, wherein the review identifies a number of the instances of harmless error code identified by the reviewer; generating a score for the review based on the number of the instances of harmless error code identified by the reviewer; and identifying additional training for the reviewer based on the number of the instances of harmless error code identified by the reviewer.

### RELATED APPLICATIONS

This application claims the benefit of, and priority to, U.S. Provisional Patent Application Ser. No. 63/715,236, filed November 1, 2024, the disclosure of which is hereby incorporated, by reference, in its entirety.

### BACKGROUND OF THE INVENTION

### 1. Field of the Invention

Embodiments relate to systems and methods for improving the effectiveness of code reviews.

### 2. Description of the Related Art

Code reviews are an important step in the software development process. Code reviews have many benefits for both the organization and individuals. However, many code reviews involve “rubber stamping,” which destroys the benefits of the code reviews.

“Rubber stamping” is the practice of approving a pull request (PR) without spending much or any time studying the code. In the worst case, a reviewer approves a PR without looking at the code at all and leaves no comments. Inadequate code reviews risk poor quality or malicious code going into production.

### SUMMARY OF THE INVENTION

Systems and methods for improving the effectiveness of code reviews are disclosed. In one embodiment, a method may include: (1) receiving, by a code review computer program and from a reviewer computer program for a reviewer, a request for code developed by a developer to review; (2) retrieving, by the code review computer program, the code from a code repository; (3) identifying, by the code review computer program, instances of harmless error code, wherein the instances of harmless error code does not impact execution of the code when embedded in the code; (4) embedding, by the code review computer program, the instances of harmless error code in the code; (5) providing, by the code review computer program, the code with the instances of harmless error code embedded therein to the reviewer computer program; (6) receiving, by the code review computer program, a review of the code with the instances of harmless error code embedded therein, wherein the review identifies a number of the instances of harmless error code identified by the reviewer; (7) generating, by the code review computer program, a score for the review based on the number of the instances of harmless error code identified by the reviewer; and (8) identifying, by the code review computer program, additional training for the reviewer based on the number of the instances of harmless error code identified by the reviewer.

In one embodiment, the instances of harmless error code are identified based on a history of reviews by the reviewer.

In one embodiment, the instances of harmless error code comprise code comprising misleading variable names, code that will never be executed, code comprising a misuse of an application programming interface function, code comprising incorrect method names, code that comprises irrelevant conditional checks, and/or violations of company standards of coding best practices.

In one embodiment, the instances of harmless error code are embedded at random locations.

In one embodiment, the instances of harmless error code are embedded at locations predicted by a machine learning algorithm or at locations identified by a large language model.

In one embodiment, the method may also include returning, by the code review computer program, the code with the instances of harmless error code embedded therein to the code repository; wherein the reviewer computer program accesses the code with the instances of harmless error code embedded therein from the code repository.

In one embodiment, the instances of harmless error code embedded therein to the code repository are provided to the reviewer computer program in a sandbox environment.

In one embodiment, the instances of harmless error code embedded therein to the code repository are provided to the reviewer computer program in a wrapper.

According to another embodiment, a system may include: a code repository comprising code; a harmless error code database comprising a plurality of instances of harmless error code; a reviewer electronic device for a reviewer executing a reviewer computer program; and an electronic device executing a code review computer program that is configured to receive, from the reviewer computer program, a request for code developed by a developer to review, to retrieve the code from the code repository, to identify instances of harmless error code in the harmless error code database, wherein the instances of harmless error code does not impact execution of the code when embedded in the code, to embed the instances of harmless error code in the code, to provide the code with the instances of harmless error code embedded therein to the reviewer computer program, to receive a review of the code with the instances of harmless error code embedded therein, wherein the review identifies a number of the instances of harmless error code identified by the reviewer, to generate a score for the review based on the number of the instances of harmless error code identified by the reviewer, and to identify additional training for the reviewer based on the number of the instances of harmless error code identified by the reviewer.

In one embodiment, the instances of harmless error code are identified based on a history of reviews by the reviewer.

In one embodiment, the instances of harmless error code comprise code comprising misleading variable names, code that will never be executed, code comprising a misuse of an application programming interface function, code comprising incorrect method names, code that comprises irrelevant conditional checks, and/or violations of company standards of coding best practices.

In one embodiment, the instances of harmless error code are embedded at random locations.

In one embodiment, the instances of harmless error code are embedded at locations predicted by a machine learning algorithm or at locations identified by a large language model.

In one embodiment, the code review computer program is further configured to return the code with the instances of harmless error code embedded therein to the code repository, and the reviewer computer program is configured to access the code with the instances of harmless error code embedded therein from the code repository.

In one embodiment, the instances of harmless error code embedded therein to the code repository are provided to the reviewer computer program in a sandbox environment.

In one embodiment, the instances of harmless error code embedded therein to the code repository are provided to the reviewer computer program in a wrapper.

According to another embodiment, a non-transitory computer readable storage medium may include instructions stored thereon, which when read and executed by one or more computer processors, cause the one or more computer processors to perform steps comprising: receiving, from a reviewer computer program for a reviewer, a request for code developed by a developer to review; retrieving the code from a code repository; identifying, based on a history of reviews by the reviewer, instances of harmless error code, wherein the instances of harmless error code does not impact execution of the code when embedded in the code, wherein the instances of harmless error code comprise code comprising misleading variable names, code that will never be executed, code comprising a misuse of an application programming interface function, code comprising incorrect method names, code that comprises irrelevant conditional checks, and/or violations of company standards of coding best practices; embedding the instances of harmless error code in the code, wherein the instances of harmless error code are embedded at random locations, at locations predicted by a machine learning algorithm, or at locations identified by a large language model; providing the code with the instances of harmless error code embedded therein to the reviewer computer program; receiving a review of the code with the instances of harmless error code embedded therein, wherein the review identifies a number of the instances of harmless error code identified by the reviewer; generating a score for the review based on the number of the instances of harmless error code identified by the reviewer; and identifying additional training for the reviewer based on the number of the instances of harmless error code identified by the reviewer.

In one embodiment, the non-transitory computer readable storage medium may also include instructions stored thereon, which when read and executed by the one or more computer processors, cause the one or more computer processors to perform steps comprising: returning the code with the instances of harmless error code embedded therein to the code repository; wherein the reviewer computer program accesses the code with the instances of harmless error code embedded therein from the code repository.

In one embodiment, the instances of harmless error code embedded therein to the code repository are provided to the reviewer computer program in a sandbox environment.

In one embodiment, the instances of harmless error code embedded therein to the code repository are provided to the reviewer computer program in a wrapper.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for improving the effectiveness of code reviews according to an embodiment;

FIG. 2 depicts a method for improving the effectiveness of code reviews according to an embodiment;

FIG. 3 depicts an exemplary computing system for implementing aspects of the present disclosure.

### DETAILED DESCRIPTION OF PREFERRED EMBODIMENTS

Embodiments relate to systems and methods for improving the effectiveness of code reviews.

Embodiments may use automation tools and artificial intelligence to embed harmless error code into code under review. Code reviewers that find the harmless error code may be rewarded.

As used herein, “harmless error code” refers to a deliberately inserted piece of code that is harmless to (i.e., does not impact) the execution of the code into which it is inserted, but is unnecessary or misleading. The purpose of the inserting harmless error code is to encourage code reviewers to engage more deeply with the code during review by identifying these elements. By doing so, harmless error code serves as a tool to promote thorough examination and critical thinking, helping to ensure that code quality is maintained and that potential issues are identified and addressed, and developers learn organization and team norms and practices. This technique leverages the natural problem-solving instincts of software engineers and developers, turning the review process into a more interactive and educational experience.

Examples of harmless error code may include code that includes misleading variable names (e.g., variable names that are not on a list); code that includes unrelated comments (e.g., comments that are unnecessary because the variables are self-documenting); “dead” code (e.g., lines of code that will never be executed); code that includes misuse of API functions (e.g., lines of code that refer to a variable not on a variable list or call an API for a purpose other than that for which it was intended); code that includes incorrect method names (e.g., code that is supposed to invoke a square root function but calculates a square); code that includes irrelevant conditional checks; code that has no effect; etc.

Embodiments may modify the harmless error code (e.g., by changing variable names and string values) to make it less recognizable and less easily searchable. In one embodiment, artificial intelligence may be used to modify the harmless error code.

As reviewers become familiar with a particular harmless error code, it will become less effective. Therefore, the harmless error codes may be updated regularly.

The harmless error code may be stored in a database to allow administrators to update the list of harmless error code easily through a graphical user interface.

The number of instances of harmless error codes in a PR may be randomly selected.

Embodiments may use a leaderboard to instill a sense of fun and competition among code reviewers.

Embodiments may enable experiments to find the best reward strategy.

Embodiments suggest and/or identify additional training based on the results.

Embodiments may improve code quality, may reduce the risk of malicious code, may ensure that best practices are followed, may leverage scalable platforms, may leverage facilities of code repository systems (e.g., webhooks, etc.) etc.

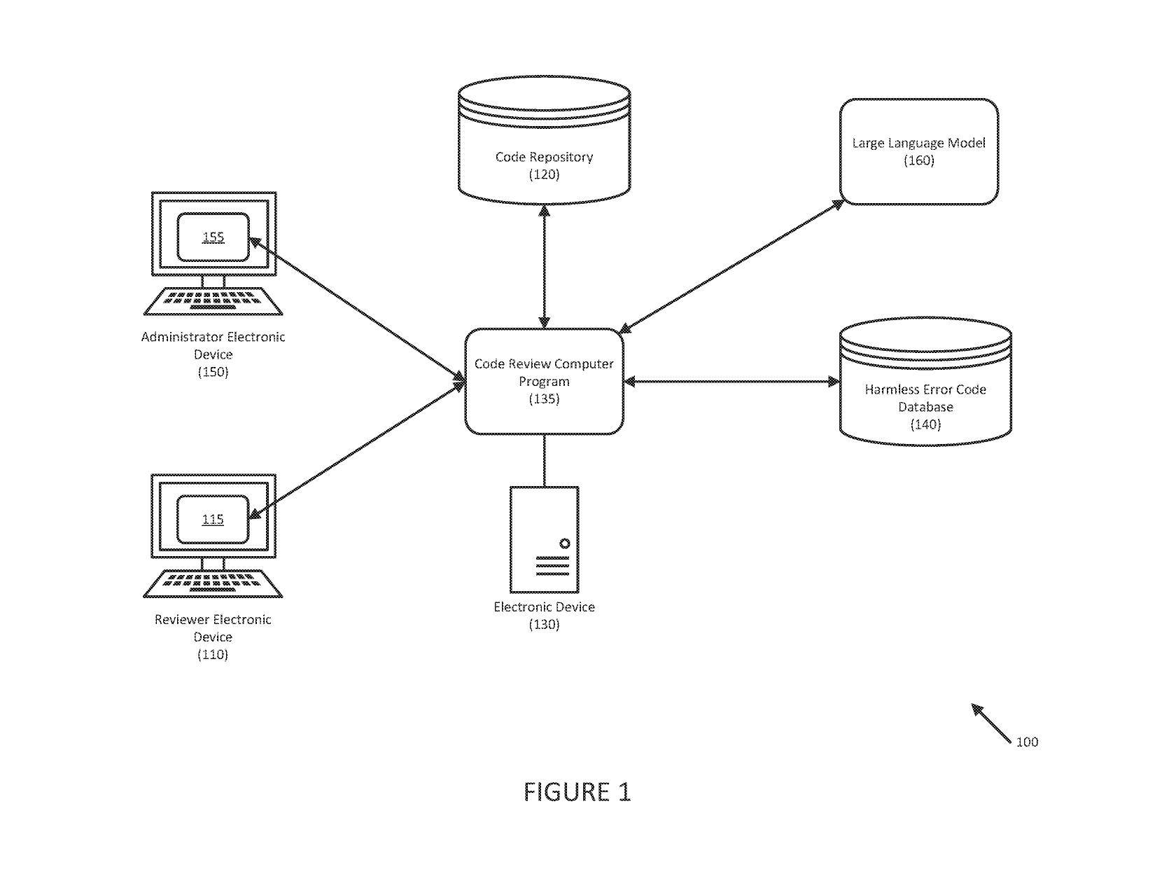

Referring to FIG. 1, a system for improving the effectiveness of code reviews is disclosed according to an embodiment. System 100 may include reviewer electronic device 110, which may be a computer (e.g., a workstation, a desktop, a laptop, a notebook, a tablet, etc.), a terminal, a smart device (e.g., a smart phone), etc. Reviewer electronic device 110 may execute reviewer computer program 115, which may allow a reviewer to access code from code repository 120 and review it for errors, conformation to programming policies and practices, etc.

Code repository 120 may store code, and may allow the code to be checked out for review, and checked back in.

Code review computer program 135 may be executed by electronic device 130, such as a server (e.g., cloud-based and/or physical), a computer, etc. Code review computer program 135 may retrieve code to be reviewed from code repository 120 and may insert harmless error code, which may be retrieved from harmless error code database 140.

System 100 may include administrator electronic device 150 that may execute administrator computer program 155. Administrator electronic device 150 may be a computer (e.g., a workstation, a desktop, a laptop, a notebook, a tablet, etc.), a terminal, a smart device (e.g., a smart phone), etc. Using administrator computer program 155, an administrator may manage harmless error code in harmless error code database 140. For example, the administrator may generate harmless error code, modify harmless error code, remove harmless error code, etc. In one embodiment, the administrator may identify harmless error code to be inserted into code as part of a review, such as in response to a pull request.

In one embodiment, the harmless code may be harvested from large language model 160.

In one embodiment, reviewer electronic device 110 and electronic device 130 may be the same electronic device, and reviewer computer program and code review computer program may be the same computer program.

The harmless error code may include errors that, when embedded in retrieved code, do not affect the execution of the retrieved code.

In one embodiment, code review computer program 135 may retrieve the code from code repository 120. In another embodiment, code review computer program 135 may make a copy of the code from code repository 120, so that the harmless error code is not embedded in the actual code.

The harmless error code in harmless error code database may be periodically refreshed.

In one embodiment, the type(s) of errors in the harmless error code may be selected based on the reviewer’s past performance in code reviews (e.g., error types that are historically not identified are more likely to be selected to be embedded in the code), may be selected based on a group the reviewer belongs to, may be selected based on an initiative (e.g., an organization may want to focus on identifying a particular type of error), etc. In one embodiment, machine learning may be used to identify the type(s) of errors to embed in the retrieved code.

The harmless error code may be selected by the administrator, or it may be automatically selected by code review computer program 135. The harmless error code may also be selected based on software engineer expertise and experience, source code analysis tools, code databases, an analysis of comments in the source code repository, an analysis of production incidents (e.g., faults that occur in a running program), a query to large language model 160, etc.

The code that is modified with the harmless error code may be stored in code repository 120, or it may be maintained within a wrapper (e.g., a software component that encapsulates the code, potentially to provide a simplified interface or to ensure compatibility with other systems or components).

System 100 may further include large language model 160, which may be used to identify locations for harmless error code to be inserted into code. For example, code review computer program 135 may submit a prompt with the code and the harmless error code for a location to insert the harmless error code.

In one embodiment, large language model may return the code with the harmless error code inserted.

Using reviewer computer program 115, the reviewer may identify errors in the code during the review. For example, the reviewer may mark and/or comment identified errors in the code. The identified errors may include the harmless error code and/or other errors in the code.

When the review is complete, the reviewer may indicate such using reviewer computer program 115, and code review computer program 135 may review the identified errors to determine the amount of embedded harmless error code that was identified. Based on the review, code review computer program 135 may generate a score, which may be a percentage of the embedded harmless error code that was identified.

Based on the review, code review computer program 135 may identify additional training for the reviewer.

Code review computer program 135 may save the score and may post the score to a leaderboard with scores for other reviewers.

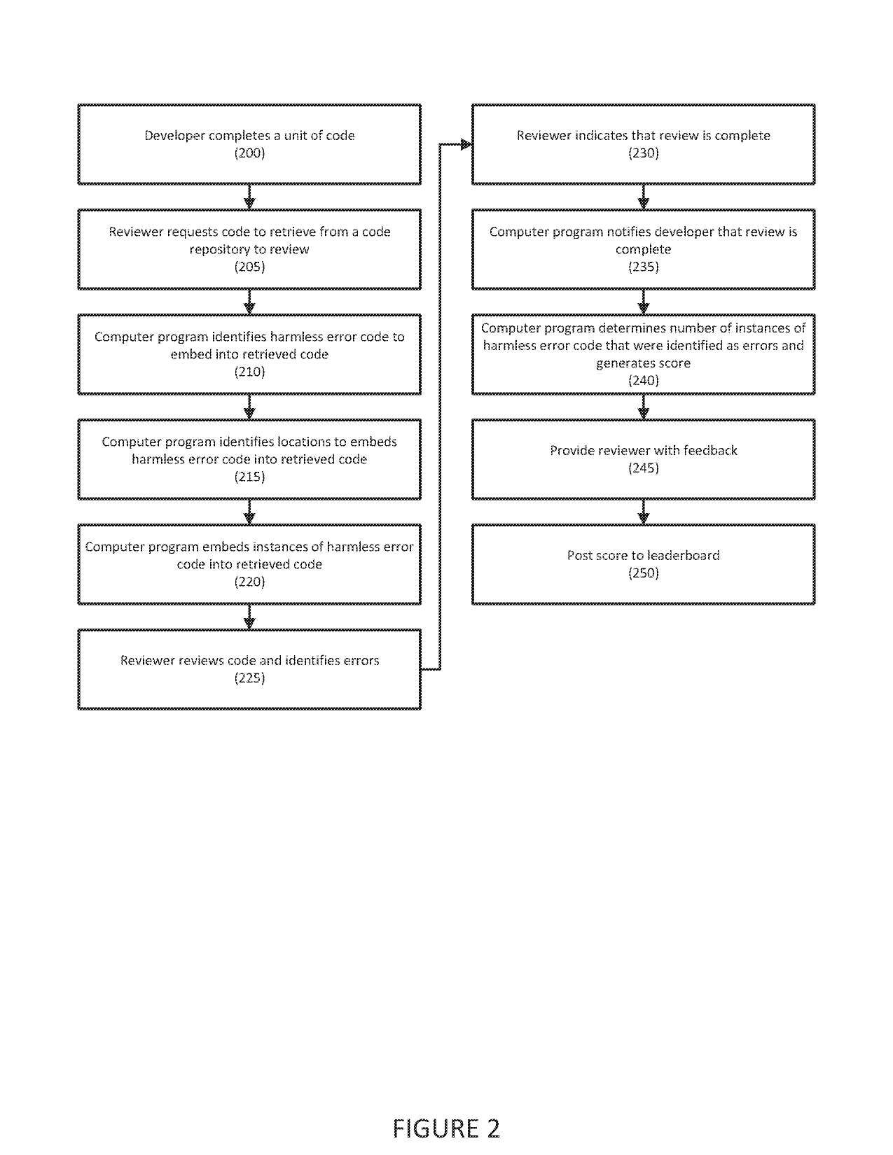

Referring to FIG. 2, a method for improving the effectiveness of code reviews is disclosed according to an embodiment.

In step 200, a developer may develop a unit of code.

In step 205, using a reviewer electronic device, a reviewer may request the unit of code to retrieve from a code repository to review the code.

In step 210, a computer program, such as a code review computer program, may retrieve the code and may identify instances of harmless error code to embed into the retrieved code. The instances of harmless error code may be identified based on the reviewer’s past performance in code reviews (e.g., error types that are historically not identified are more likely to be selected to be embedded in the code), on a group the reviewer belongs to, on an initiative (e.g., an organization may want to focus on identifying a particular type of error), etc.

In one embodiment, the code review computer program may retrieve the code from the code repository. In another embodiment, the code review computer program may make a copy of the code from the code repository so that the instances of harmless error code are not embedded in the actual code, and may provide the code to the reviewer in a sandbox environment.

In step 215, the code review computer program may identify locations to embed the instances of harmless error code into retrieved code. In one embodiment, the locations may be randomly selected. In another embodiment, the code review computer program may use machine learning to identify the location to insert the instances of harmless error code. In another embodiment, the code review computer program may query a large language model with the retrieved code and the instances of harmless error for a location to embed the harmless error code.

In step 220, the code review computer program may embed the instances of harmless error code into the retrieved code at the identified locations.

In step 225, using the reviewer computer program, the reviewer may review the code and may identify errors in the code, including the instances of the harmless error code and other errors. The reviewer may mark, annotate, or comment on the identifier errors.

In step 230, the reviewer may indicate that the review is complete. The reviewer may check the code back into the code repository, or otherwise indicate that the review is complete, and in step 235, the computer program may notify the developer that the review is complete.

In step 240, the code review computer program may determine the number of instances of harmless error code that were identified as errors and may generate a score for the review.

If the code is checked into the code repository, the code review computer program may remove the embedded harmless errors from the code.

In step 245, the code review computer program may provide the reviewer with feedback. For example, the code review computer program may identify the harmless error code instances that were identified by the reviewer, the harmless error code instances that were not identified by the review and may provide a score. The score may be a percentage, a letter grade, etc.

In one embodiment, the code review computer program may identify additional training for the reviewer based on the review. For example, if the reviewer repeatedly missed a certain type of error, the code review computer program may provide training on identifying that type of error.

In step 250, the code review computer program may post the score to a leaderboard with scores from other reviewers.

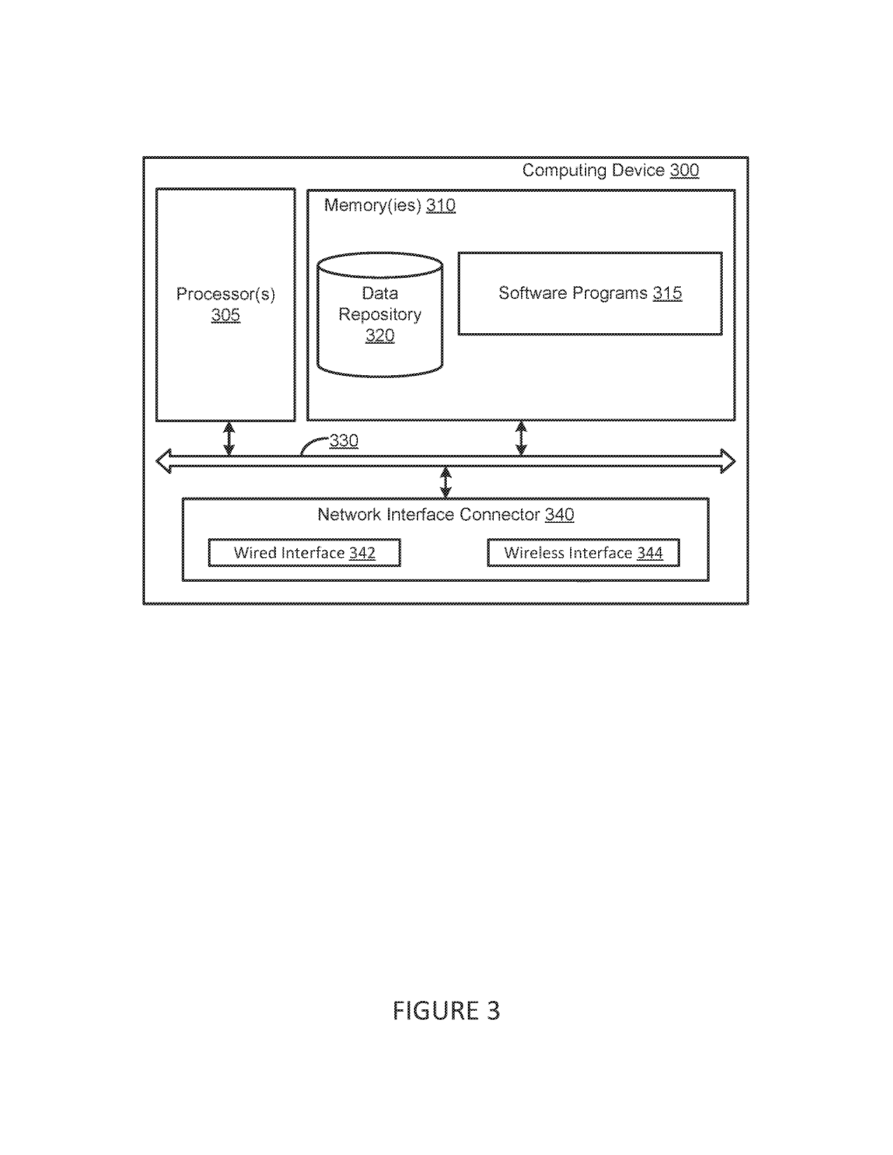

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as HTTP, HTTPS, TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented and/or functional programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a code review computer program and from a reviewer computer program for a reviewer, a request for code developed by a developer to review;
retrieving, by the code review computer program, the code from a code repository;
identifying, by the code review computer program, instances of harmless error code, wherein the instances of harmless error code does not impact execution of the code when embedded in the code;
embedding, by the code review computer program, the instances of harmless error code in the code;
providing, by the code review computer program, the code with the instances of harmless error code embedded therein to the reviewer computer program;
receiving, by the code review computer program, a review of the code with the instances of harmless error code embedded therein, wherein the review identifies a number of the instances of harmless error code identified by the reviewer;
generating, by the code review computer program, a score for the review based on the number of the instances of harmless error code identified by the reviewer; and
identifying, by the code review computer program, additional training for the reviewer based on the number of the instances of harmless error code identified by the reviewer.

2. The method of claim 1, wherein the instances of harmless error code are identified based on a history of reviews by the reviewer.

3. The method of claim 1, wherein the instances of harmless error code comprise code comprising misleading variable names, code that will never be executed, code comprising a misuse of an application programming interface function, code comprising incorrect method names, code that comprises irrelevant conditional checks, and/or violations of company standards of coding best practices.

4. The method of claim 1, wherein the instances of harmless error code are embedded at random locations.

5. The method of claim 1, wherein the instances of harmless error code are embedded at locations predicted by a machine learning algorithm or at locations identified by a large language model.

6. The method of claim 1, further comprising:
returning, by the code review computer program, the code with the instances of harmless error code embedded therein to the code repository;
wherein the reviewer computer program accesses the code with the instances of harmless error code embedded therein from the code repository.

7. The method of claim 1, wherein the instances of harmless error code embedded therein to the code repository are provided to the reviewer computer program in a sandbox environment.

8. The method of claim 1, wherein the instances of harmless error code embedded therein to the code repository are provided to the reviewer computer program in a wrapper.

9. A system, comprising:
a code repository comprising code;
a harmless error code database comprising a plurality of instances of harmless error code;
a reviewer electronic device for a reviewer executing a reviewer computer program; and
an electronic device executing a code review computer program that is configured to receive, from the reviewer computer program, a request for code developed by a developer to review, to retrieve the code from the code repository, to identify instances of harmless error code in the harmless error code database, wherein the instances of harmless error code does not impact execution of the code when embedded in the code, to embed the instances of harmless error code in the code, to provide the code with the instances of harmless error code embedded therein to the reviewer computer program, to receive a review of the code with the instances of harmless error code embedded therein, wherein the review identifies a number of the instances of harmless error code identified by the reviewer, to generate a score for the review based on the number of the instances of harmless error code identified by the reviewer, and to identify additional training for the reviewer based on the number of the instances of harmless error code identified by the reviewer.

10. The system of claim 9, wherein the instances of harmless error code are identified based on a history of reviews by the reviewer.

11. The system of claim 9, wherein the instances of harmless error code comprise code comprising misleading variable names, code that will never be executed, code comprising a misuse of an application programming interface function, code comprising incorrect method names, code that comprises irrelevant conditional checks, and/or violations of company standards of coding best practices.

12. The system of claim 9, wherein the instances of harmless error code are embedded at random locations.

13. The system of claim 9, wherein the instances of harmless error code are embedded at locations predicted by a machine learning algorithm or at locations identified by a large language model.

14. The system of claim 9, wherein the code review computer program is further configured to return the code with the instances of harmless error code embedded therein to the code repository, and the reviewer computer program is configured to access the code with the instances of harmless error code embedded therein from the code repository.

15. The system of claim 9, wherein the instances of harmless error code embedded therein to the code repository are provided to the reviewer computer program in a sandbox environment.

16. The system of claim 9, wherein the instances of harmless error code embedded therein to the code repository are provided to the reviewer computer program in a wrapper.

17. A non-transitory computer readable storage medium, including instructions stored thereon, which when read and executed by one or more computer processors, cause the one or more computer processors to perform steps comprising:
receiving, from a reviewer computer program for a reviewer, a request for code developed by a developer to review;
retrieving the code from a code repository;
identifying, based on a history of reviews by the reviewer, instances of harmless error code, wherein the instances of harmless error code does not impact execution of the code when embedded in the code, wherein the instances of harmless error code comprise code comprising misleading variable names, code that will never be executed, code comprising a misuse of an application programming interface function, code comprising incorrect method names, code that comprises irrelevant conditional checks, and/or violations of company standards of coding best practices;
embedding the instances of harmless error code in the code, wherein the instances of harmless error code are embedded at random locations, at locations predicted by a machine learning algorithm, or at locations identified by a large language model;
providing the code with the instances of harmless error code embedded therein to the reviewer computer program;
receiving a review of the code with the instances of harmless error code embedded therein, wherein the review identifies a number of the instances of harmless error code identified by the reviewer;
generating a score for the review based on the number of the instances of harmless error code identified by the reviewer; and
identifying additional training for the reviewer based on the number of the instances of harmless error code identified by the reviewer.

18. The non-transitory computer readable storage medium of claim 17, further including instructions stored thereon, which when read and executed by the one or more computer processors, cause the one or more computer processors to perform steps comprising:
returning the code with the instances of harmless error code embedded therein to the code repository;
wherein the reviewer computer program accesses the code with the instances of harmless error code embedded therein from the code repository.

19. The non-transitory computer readable storage medium of claim 17, wherein the instances of harmless error code embedded therein to the code repository are provided to the reviewer computer program in a sandbox environment.

20. The non-transitory computer readable storage medium of claim 17, wherein the instances of harmless error code embedded therein to the code repository are provided to the reviewer computer program in a wrapper.
